(19) United States
(12) Patent Application Publication
(10) Pub. No.: US 2008/0313586 A1
(43) Pub. Date: Dec. 18, 2008

(54) Resistance net generating apparatus for circuit simulation

(75) Inventor: Naoya Takaki, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/155,284

(22) Filed: Jun. 2, 2008

(30) Foreign Application Priority Data
Jun. 14, 2007 (JP) 2007-157335

(51) Int. Cl. G06F 17/50

(52) U.S. Cl. 716/5

(57) ABSTRACT

In an aspect of the present invention, a resistance net generating apparatus includes a dividing section configured to acquire a data of a wiring pattern which contains connection position with vias and to divide the wiring pattern into rectangular patterns; a division pattern processing section configured to set nodes and resistances base on the rectangular patterns; and an output section configured to output positions of the nodes and the resistances as a resistance net specifying data. The wiring pattern is represented by sidelines extending into an X direction and a Y direction orthogonal to the X direction. The dividing section divides the wiring pattern into the rectangular patterns by extension lines extending from the sidelines into an inside of the wiring pattern.

### INCORPORATION BY REFERENCE

This application is based on Japanese Patent Application No. JP 2007-157335. The disclosure thereof is incorporated herein by reference.

### BACKGROUND OF THE INVENTION

1. Field of the Invention

The present invention relates to a resistance net generating apparatus for generating a resistance net data for a circuit simulation.

2. Description of Related Art

When a circuit such as a semiconductor integrated circuit is to be designed, a layout pattern showing shapes of wirings, arrangement of vias connecting layers, and the like is first designed. Next, how a circuit having the layout pattern operates is verified through simulation. If a problem is discovered as a result of the verification, the layout pattern is re-designed.

As a layout pattern verifying method, there are known, for example, EM (electro-migration) verification and IR-Drop verification. To perform the EM verification or the IR-Drop verification, it is necessary to prepare simulation data (e.g., resistance net netlist) indicating a circuit connection state. Accordingly, before the verification is performed, the simulation data is generated based on the layout pattern. Namely, when the circuit simulation is to be performed, the layout pattern is designed, the simulation data is generated, and the verification such as the EM verification is performed as shown in FIG. 1A.

As a simulation data generating method, Japanese Patent Application Publications (JP-A-Heisei 7-249057, and JP-A-Heisei 10-269267) are known. For accurate simulation, it is important that the simulation data accurately represents a connection state of the circuit in the layout pattern.

Generally, when the simulation data is to be generated, vias connecting two different wiring layers are represented as follows. Here, it should be noted that although such representations as “a node is set” and “a resistance is set” are often used below, these representations are assumed to indicate that the node or resistance as data is set.

As shown in FIG. 2, it is assumed that ten vias (v1 to v10) are connected to a wiring pattern m1 in a wiring layer in the layout pattern. Among the ten vias, it is assumed that the vias v1 to v4 are connected to a wiring pattern m2 in another wiring layer and that the vias v5 to v10 are connected to another wiring pattern m3. For the layout pattern shown in FIG. 2, the vias v1 to v4 connected to the wiring pattern m1 are merged into a via V1 and the vias v5 to v10 connected to the wiring pattern m2 are merged into a via V2 as shown in FIG. 3. Resistance values of the vias V1 and V2 are calculated based on preset resistance values of the vias v1 to v10 before the merging. Therefore, the wiring patterns m1 and m2 are regarded to be connected to each other by the single via V1 (resistance) in portions of the vias v1 to v4. Similarly, the wiring patterns m1 and m3 are regarded to be connected to each other by the single via V2 (resistance) in portions of the vias v5 to v10. Accordingly, the connection among the wiring layers is represented by using the vias V1 and V2 obtained through the merging in the simulation data. It should be noted that a resistance between the vias V1 and V2 is represented as a resistance connecting a center P of the via V1 to a center Q of the via V2 in the wiring pattern m1.

Actually, in the layout in which the wiring patterns are connected to one another by a plurality of vias, current is branched or currents are synthesized near connection portions. However, if the verification is performed by using the method described with reference to FIGS. 2 and 3, directions of signals (currents) near the connection portions are often represented incorrectly because of merging the plurality of vias into the single via. Therefore, it is difficult to identify how much current flows through the respective vias before the merging.

In conjunction with the above-stated conventional technique, Japanese Patent No. 3,017,131 discloses that meshed resistances are allocated to a wiring pattern to generate simulation data. In the above Japanese patent No. 3,017,131, the simulation data is generated in a manner shown in FIG. 1B. Namely, wirings of a semiconductor integrated circuit are first divided into wiring elements. A pseudo-resistance net in which electric resistances are connected in the form of mesh via nodes is formed for every wiring element. Resistance values of the respective wring elements are calculated and a calculation result is set as a resistance net.

If the layout method described in the above Japanese Patent No. 3,017,131 is used, it is considered that a connection state of the circuit can be represented more accurately by making meshes finer. However, if the meshes are made finer, a data size of the simulation data increases so that a processing time by a computer often becomes long.

If the simulation data for the layout pattern as shown in FIG. 2 is generated by using the layout method described in the above Japanese patent No. 3,017,131, a resistance net shown in FIG. 4 is considered to be generated. As shown in FIG. 4, groups of unnecessary resistances, one end of each of which is connected to nothing, is generated in a peripheral portion of the simulation pattern. These unnecessary resistance groups also cause an increase in the data size. Therefore, it is desired to provide a technique of suppressing the increase in the data size while accurately representing a connection state of the circuit.

In FIG. 4, vias denoted with −1 as V1-1, V2-1, . . . and V10-1 indicate the vias before generating the simulation data. If the resistance nets are allocated in the form of mesh, the vias V1-1 to V10-1 are often displaced from cross-points (nodes) in the resistance net. In this case, the vias V1-1 to V10-1 are moved to proximate nodes in the simulation data. As a result, in the simulation data, a coordinate of each of the vias may be possibly displaced from an original coordinate thereof (in the layout pattern) by a/2 at maximum (a is a mesh division size and corresponds to “a” in FIG. 4). If a defective via is detected as an error as a result of the EM verification, the coordinate of the via is outputted. It should be noted that it is difficult to identify which of the vias in the layout pattern corresponds to the via detected as the error to which via if positions (coordinates) of the vias are displaced from actual positions (coordinates) thereof in the simulation data.

Therefore, a technique for generating simulation data is desired in which positions of the vias in verification can be easily identified.

### SUMMARY

In an aspect of the present invention, a resistance net generating apparatus includes a dividing section configured to acquire a data of a wiring pattern which contains connection position with vias and to divide the wiring pattern into rectangular patterns; a division pattern processing section configured to set nodes and resistances base on the rectangular patterns; and an output section configured to output positions of the nodes and the resistances as a resistance net specifying data. The wiring pattern is represented by sidelines extending into an X direction and a Y direction orthogonal to the X direction. The dividing section divides the wiring pattern into the rectangular patterns by extension lines extending from the sidelines into an inside of the wiring pattern.

In another aspect of the present invention, a resistance net generating apparatus includes a dividing section configured to acquire a wiring pattern which contains connection position with vias and to divide the wiring pattern into rectangular patterns; a division pattern processing section configuration to set nodes and resistances based on the rectangular patterns; a via rectangular pattern processing section configured to set nodes and resistances to a via pattern for the vias; and an output section configured to output positions of the resistance and the node as resistance net specifying data. The via pattern is a via rectangular pattern containing the connection position of the vias. The via rectangular pattern processing section sets to the via rectangular pattern, a central node at a center of the via rectangular pattern, a via node in a center of the connection position of the via, a first perpendicular line extending from the central node to each of sidelines of the via rectangular pattern, a second perpendicular line extending from the via node to the first perpendicular line, and a perpendicular line node at a cross point of the first and second perpendicular lines. The division pattern processing section and the via rectangular pattern processing section set the resistances to connect the nodes.

In still another aspect of the present invention, a computer-readable software medium in which codes of a program for a resistance net generating method are stored, wherein the resistance net generating method includes acquiring a data of a wiring pattern which contains connection position with vias, wherein the wiring pattern is represented by sidelines extending into an X direction and a Y direction orthogonal to the X direction; dividing the wiring pattern into rectangular patterns by extension lines extending from the sidelines into an inside of the wiring pattern; setting nodes and resistances base on the rectangular patterns; and outputting positions of the nodes and the resistances as a resistance net specifying data.

According to the present invention, the resistance net generating apparatus is provided which can suppress a data size while accurately representing a connection state of wiring patterns and vias by minimum nodes and minimum resistances.

### BRIEF DESCRIPTION OF THE DRAWINGS

The above and other objects, advantages and features of the present invention will be more apparent from the following description of certain embodiments taken in conjunction with the accompanying drawings, in which:

FIGS. 1A and 1B are flowcharts showing conventional circuit simulation operating methods;

FIG. 2 is a schematic diagram showing a wiring pattern;

FIG. 3 is a schematic diagram showing a resistance net in which vias are merged into a single via according to a conventional technique;

FIG. 4 is a schematic diagram showing the resistance net generated according to a conventional technique;

FIG. 5 is a block diagram schematically showing a configuration of a resistance net generating apparatus according to a first embodiment of the present invention;

FIG. 6 is a block diagram showing a functional configuration of the resistance net generating apparatus in the first embodiment;

FIG. 7 is a flowchart showing an operation of the resistance net generating apparatus in the first embodiment;

FIGS. 8 to 14 are diagrams showing generation of a resistance net from wiring patterns in the resistance net generating apparatus in the first embodiment;

FIGS. 15 to 18 are diagrams showing processing of a via-containing rectangular pattern in the first embodiment;

FIGS. 19 to 21 are diagrams showing an operation of the via-containing rectangular pattern processing in the resistance net generating apparatus according to a second embodiment of the present invention;

FIG. 22 is a conceptual diagram showing content of layout patterns in an example;

FIG. 23 is a conceptual diagram showing each of basic data;

FIGS. 24 and 25 are diagrams showing wiring patterns on M1 and M2 layers, respectively;

FIGS. 26 and 27 are tables showing DC analysis results in the example and first and second comparison examples, respectively;

FIG. 28 is a table showing the number of resistances in the resistance nets in the example and the first and second comparison examples, respectively; and

FIG. 29 is a table showing execution time required for the DC analyses in the example and the first and second comparison examples, respectively.

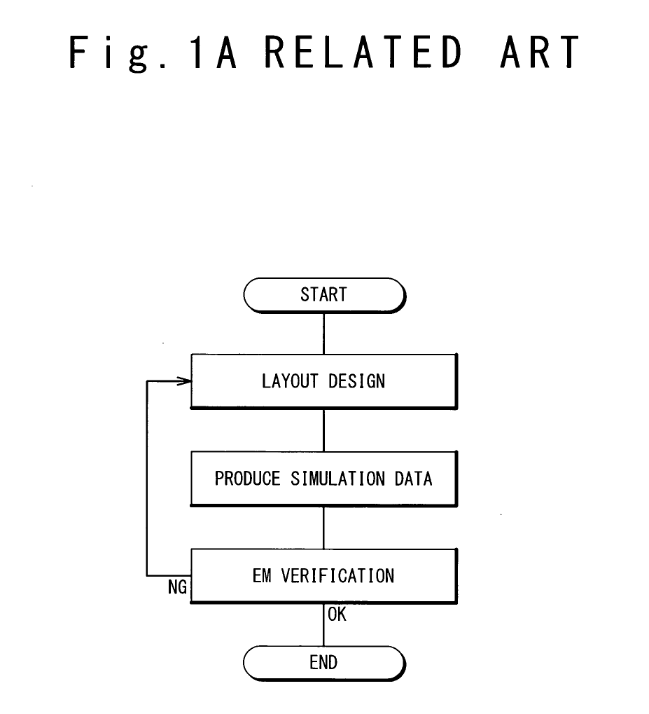

### DESCRIPTION OF THE PREFERRED EMBODIMENTS

Hereinafter, a resistance net generating apparatus of the present invention will be described in detail with reference to the attached drawings.

### First Embodiment

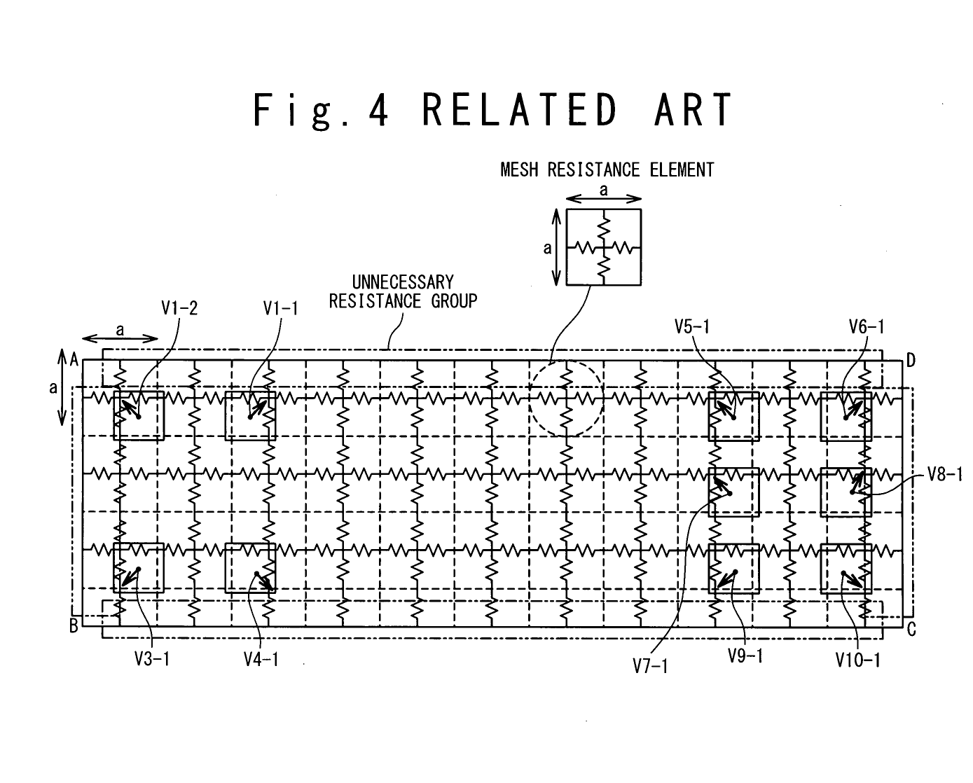

FIG. 5 is a block diagram schematically showing a configuration of a resistance net generating apparatus 10 according to a first embodiment of the present invention. As shown in FIG. 5, the resistance net generating apparatus 10 acquires a layout pattern stored in a layout data storage section 20 in advance, generates a resistance net (netlist), and outputs the generated resistance net. The resistance net generating apparatus 10 includes a CPU, a RAM (Random Access Memory), a ROM (Read Only Memory), and an input/output interface (I/O) connected with an input unit and an output unit (both not shown). Functions of the resistance net generating apparatus 10 are realized by a resistance net generation program stored in the ROM. The layout pattern data stored in the layout data storage section 20 includes data indicating wiring patterns of a plurality of wiring layers, and positions of vias connecting the wiring layers.

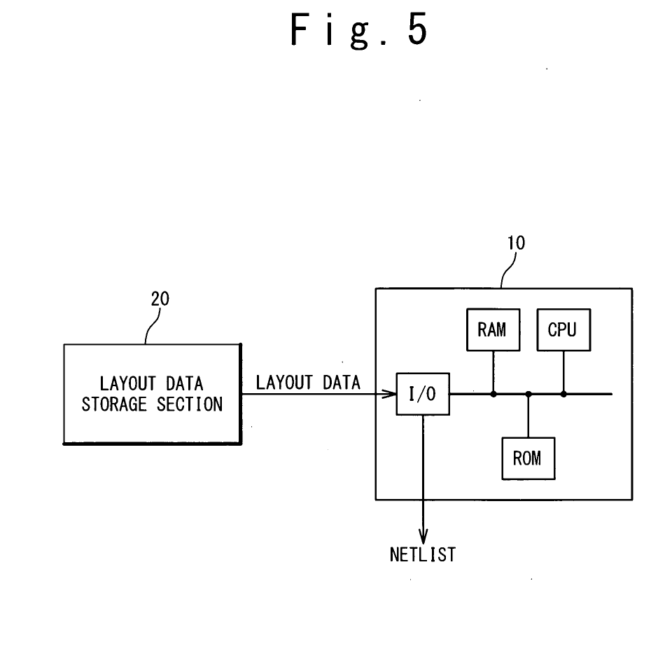

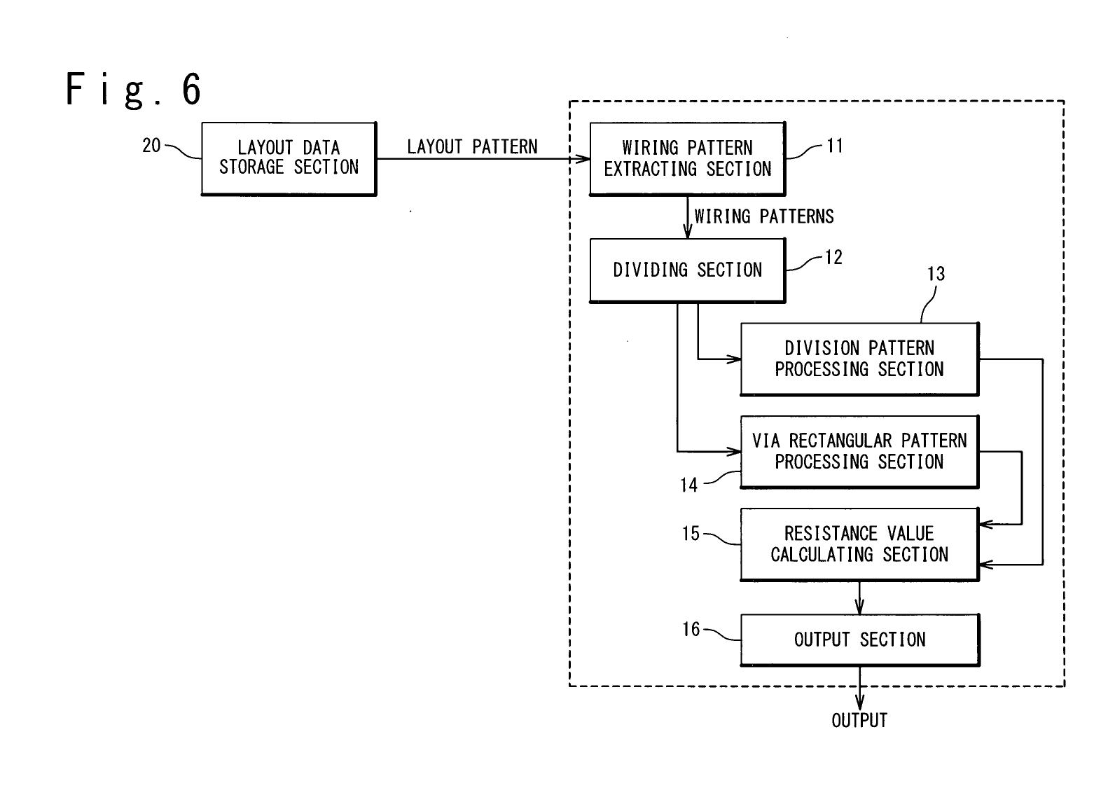

FIG. 6 is a block diagram schematically showing a function configuration of the resistance net generating apparatus 10. As shown in FIG. 6, the resistance net generating apparatus 10 includes a wiring pattern extracting section 11, a dividing section 12, a division pattern processing section 13, a via rectangular pattern processing section 14, a resistance value calculating section 15, and an output section 16. The resistance net generating apparatus 10 operates in accordance with a flow shown in FIG. 7. This operation is realized by the resistance net generation program installed in, for example, the ROM.

The operation performed by the resistance net generating apparatus 10 will be described with reference to FIG. 7.

### Step S10: Extract Wiring Patterns

The wiring pattern extracting section 11 extracts wiring patterns from the layout pattern data acquired from the layout data storage section 20. Specifically, the wiring pattern extracting section 11 divides a layout pattern specified the layout pattern data into wiring patterns for every wiring layer. More specifically, the wiring pattern extracting section 11 divides the layout pattern of each wiring layer into a Metal-1 pattern, a Metal-2 pattern, . . . At this time, vias connecting the wiring layers are represented as patterns on the wiring patterns to which the vias are connected. Also, each of the wiring patterns extracted to be represented by segments extending in an X direction and a Y direction orthogonal to the X direction.

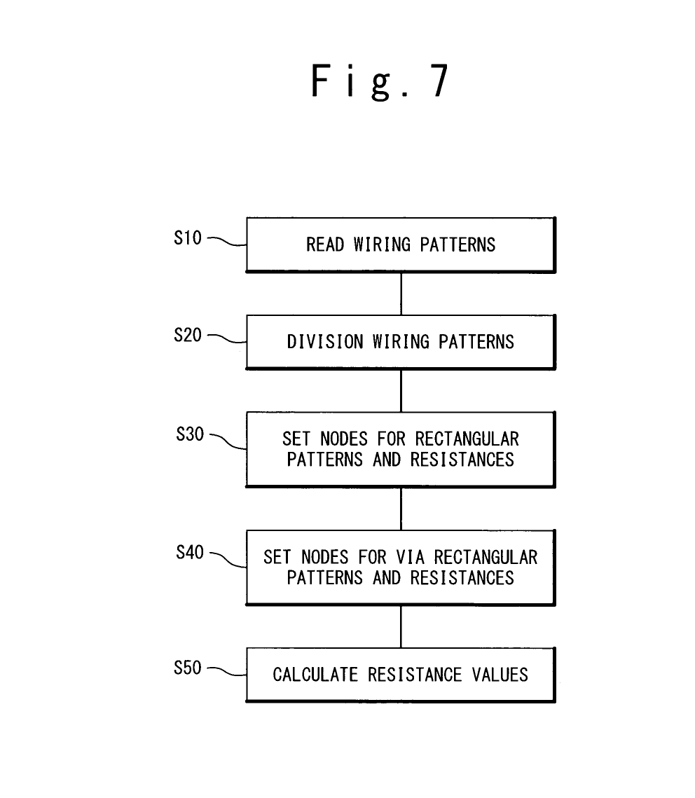

In the first embodiment, it is assumed that a pattern as shown in FIG. 8 is extracted as one wiring pattern. The wiring pattern shown in FIG. 8 includes portions for two terminals (ABQR and MNKL) and portions of four conductors (BCDQ, PEIO, NIJK, and EFGH). Further, two connection positions (VIA-1 and VIA-2) at which the wiring pattern is connected to vias are shown in this wiring pattern.

### Step S20: Divide Wiring Pattern

Next, the dividing section 12 divides each of all the wiring patterns extracted by the wiring pattern extracting section 11 into rectangular patterns (hereinafter, to be referred to as “rectangular patterns”). At this time, the dividing section 12 divides the wiring patterns by extending each of sidelines of each pattern into another pattern.

The step S20 will be specifically described with reference to an instance of dividing the wiring pattern shown in FIG. 8 into rectangular patterns. When the dividing section 12 is to divide the wiring pattern shown in FIG. 8 into rectangular patterns, the following two procedures are executed.

(Procedure-1) When a vertex of a pattern adjacent to a target pattern is present on a sideline (a location other than vertexes) of the target pattern, a sideline of the adjacent pattern is extended to divide the target pattern with the extended sideline.

(Procedure-2) When a segment dividing the adjacent pattern is orthogonal to the sideline of the target pattern at a location other than the vertexes, this segment is extended to divide the target pattern with the extended segment.

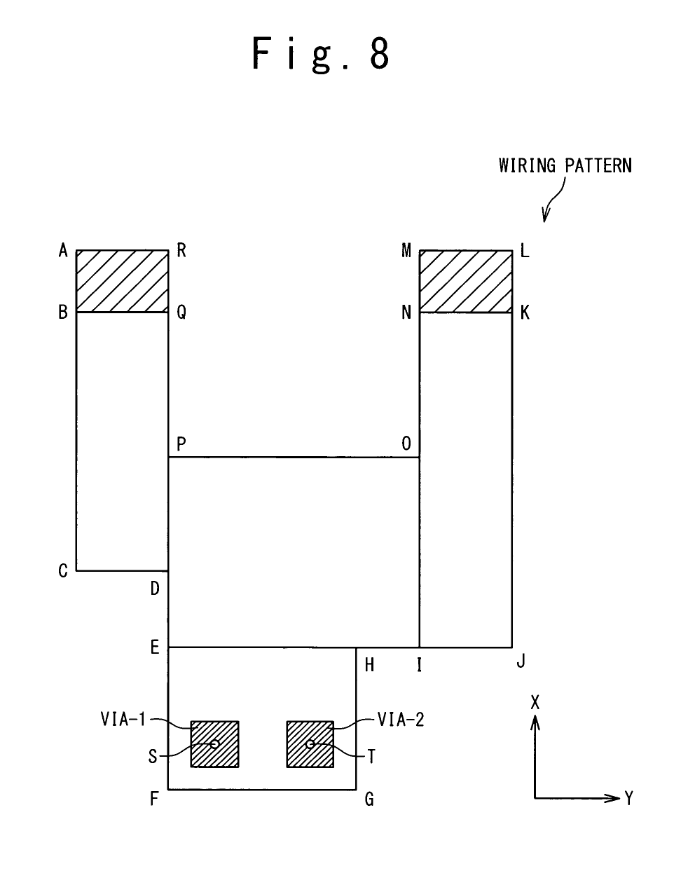

That is, if the pattern BCDQ is a target pattern, the target pattern BCDQ is divided as shown in FIG. 9. The pattern BCDQ contacts with the terminal pattern ABQR and the rectangular pattern PEIO. The pattern BCDQ contacts with the terminal pattern ABQR of these patterns ABQR and PEIO on the same sideline (BQ). None of the vertexes of the terminal pattern ABQR other than vertexes B and Q are present on the sideline BQ other than ends. Therefore, the rectangular pattern ABQR is not divided in view of connection to the terminal pattern ABQR. On the other hand, if attention is paid to the connection between the pattern BCDQ and pattern PEIO, the pattern BCDQ contacts with the pattern PEIO on a sideline DQ. In this case, the sideline DQ of the pattern BCDQ crosses a sideline OP of the pattern PEIO at a point P, i.e., a location other than vertexes of the rectangular pattern BCDQ. Accordingly, the pattern BCDQ is divided in accordance with the procedure 1. Specifically, as shown by an arrow in FIG. 9, the segment OP extends into the inside of the pattern BCDQ in a direction from O to P, up to a point U on a sideline BC. Thus, the pattern BCDQ is divided into two rectangular patterns BUPQ and UCDP by this extension line PU.

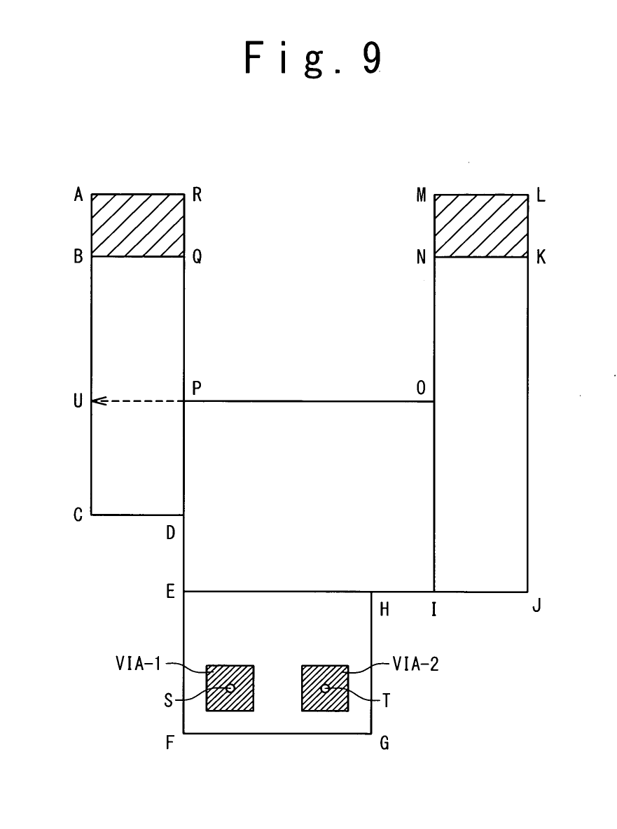

Moreover, if attention is paid to the pattern PEIO, the pattern PEIO is divided as shown in FIG. 10. The pattern PEIO contacts with the patterns BCDQ, NIJK, and EFGH. The connection of the pattern PEIO to the pattern BCDQ is considered. A sideline PE of the pattern PEIO is orthogonal to a sideline CD of the pattern BCDQ. Therefore, the segment CD is extended in a direction from C to D. A cross-point between this extension line and a sideline IO of the pattern PEIO is set as V. Subsequently, a connection of the pattern PEIO to the pattern NIJK is considered. The pattern PEIO contacts with the pattern NIJK on a sideline OI, but the sideline OI is orthogonal to a sideline IJ of the pattern NIJK at a vertex I of the pattern PEIO. Since the sideline OI is orthogonal to the sideline IJ of the pattern NIJK at the vertex I, the pattern PEIO is not divided in view of the connection to the pattern NIJK. On the other hand, the connection of the pattern PEIO to the pattern EFGH is next considered. A sideline EI of the pattern PEIO is orthogonal to two sidelines EF and GH of the pattern EFGH. Among these, a cross-point between the sideline EI of the pattern PEIO and the sideline EF of the pattern EFGH is a vertex E. Therefore, the pattern PEIO is not divided by the side EF of the pattern EFGH. On the other hand, the side EI of the pattern PEIO is orthogonal to the sideline GH of the pattern EFGH at a location H other than the vertexes of the pattern PEIO. Therefore, the segment GH is extended in a direction from G to H in accordance with the procedure 1. A cross-point between this extension line and the sideline OP is set as W. Further, a cross-point between extension lines DV and HW is set as X. As a result, the pattern PEIO is divided into four rectangular patterns PDXW, WXVO, DEHX, and XHIV by the two segments DV and HW.

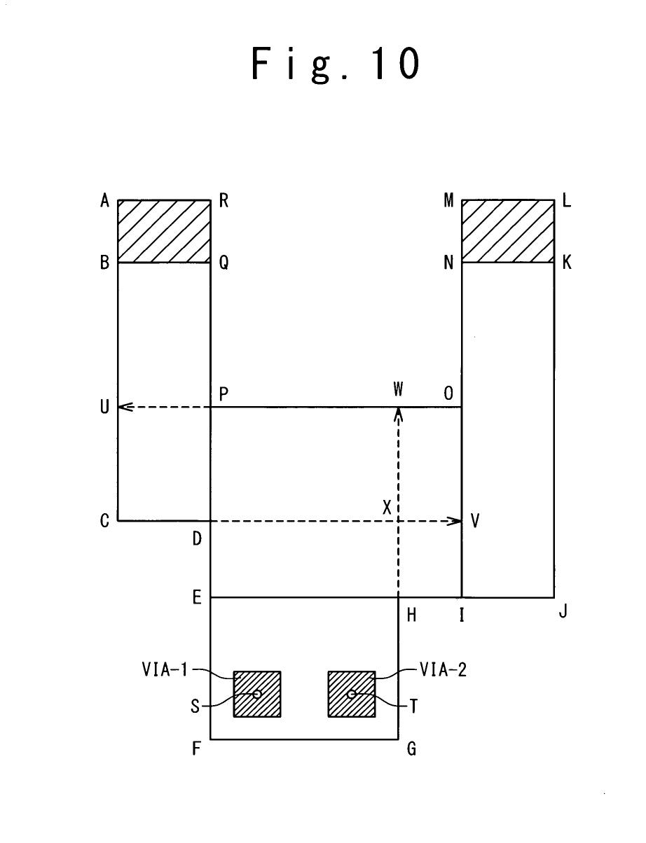

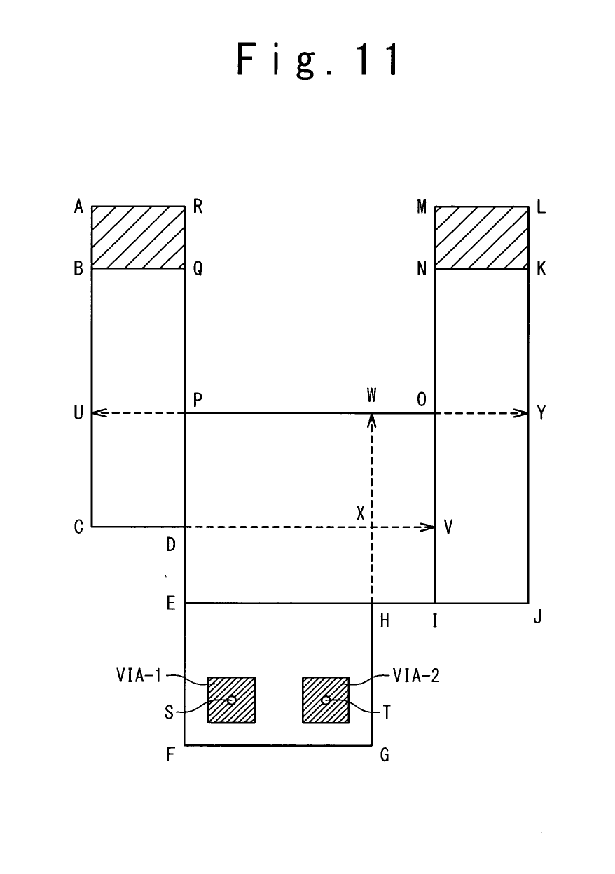

If attention is paid to the pattern NIJK, the pattern NIJK is divided as shown in FIG. 11 in accordance with the procedure 1, and also divided as shown in FIG. 12 in accordance with the procedure 2. The pattern NIJK contacts with the terminal pattern MNKL and the pattern PEIO. Of these patterns MNKL and PEIO, the pattern NIJK contacts with the terminal pattern MNKL on the same sideline NK but vertexes of the terminal pattern MNKL other than vertexes N and K that are also vertexes of the pattern NIJK are not present on the sideline NK. Therefore, the pattern NIJK is not divided in view of the connection to the terminal pattern MNKL. Subsequently, the connection of the pattern NIJK to the pattern PEIO is considered. The sideline NI of the pattern NIJK is orthogonal to a sideline PO of the pattern PEIO at a location O other than the vertexes of the pattern NIJK. Therefore, the segment PO is extended in a direction from P to O. A cross-point between this extension line and a sideline JK of the pattern NIJK is set as Y. The pattern NIJK is divided into rectangular patterns NOYK and OIJY by an extension line OY. Further, the sideline NI of the pattern NIJK is orthogonal to an extension line DV dividing the pattern PEIO at a location V other than the vertexes of the pattern NIJK. Therefore, this extension line DV is further extended in a direction from D to V in accordance with the procedure 2. A cross-point between this extension line and the sideline JK of the pattern NIJK is set as Z. As a result, the rectangular pattern OIJY is divided into two rectangular patterns OVZY and VIJZ by the extension line VZ. Namely, the pattern NIJK is divided into the three rectangular patterns NOYK, OVZY, and VIJZ by the two segments OY and VZ.

If attention is paid to the terminal patterns ABQR and MNKL and to the pattern EFGH, extension lines satisfying the procedures 1 and 2 and dividing the patterns ABQR, MNKL, and EFGH are not present. Therefore, these patterns ABQR, MNKL, and EFGH are not divided.

Through the above-mentioned process, the extracted wiring pattern is finally divided into a plurality of rectangular patterns 1-1 to 1-12 as shown in FIG. 12.

In the first embodiment, the instance in which the wiring pattern is represented as a plurality of rectangular patterns in advance has been described as shown in FIG. 8. However, as far as the wiring pattern is represented so that the sidelines of the patterns extend in the X or Y direction, the wiring pattern can be divided not by a plurality of rectangular patterns but by extension lines similarly obtained by extending the respective sidelines into the patterns. For example, in FIG. 8, even if the patterns BCDQ, PEIO, and NIJK are combined, the wiring pattern is finally divided into the rectangular patterns 1-1 to 1-12 as shown in FIG. 12.

Moreover, as will be described later in detail for subsequent embodiments, if the wiring pattern is a pattern including only one wiring rectangle, a wiring pattern after the division is represented by the same rectangular pattern as that of the wiring pattern before the division. In the present invention, such a case is also contained in a definition that a wiring pattern is divided into rectangular patterns.

### Step S30: Set Nodes and Resistances to Division Patterns.

Next, the division pattern processing section 13 sets nodes and resistances for the rectangular patterns, respectively. At this time, the division pattern processing section 13 generates nodes by using the following two algorithms (A) and (B).

(A) Generate a nodes at center point of each of the rectangular patterns (hereinafter, to be referred to as “pattern central nodes 2-4”).

(B) Generate a node at a cross-point of a segment between the central points of two adjacent rectangular patterns and a segment contacting with the adjacent rectangular patterns (hereinafter, to be referred to as a “side central node 2-5”).

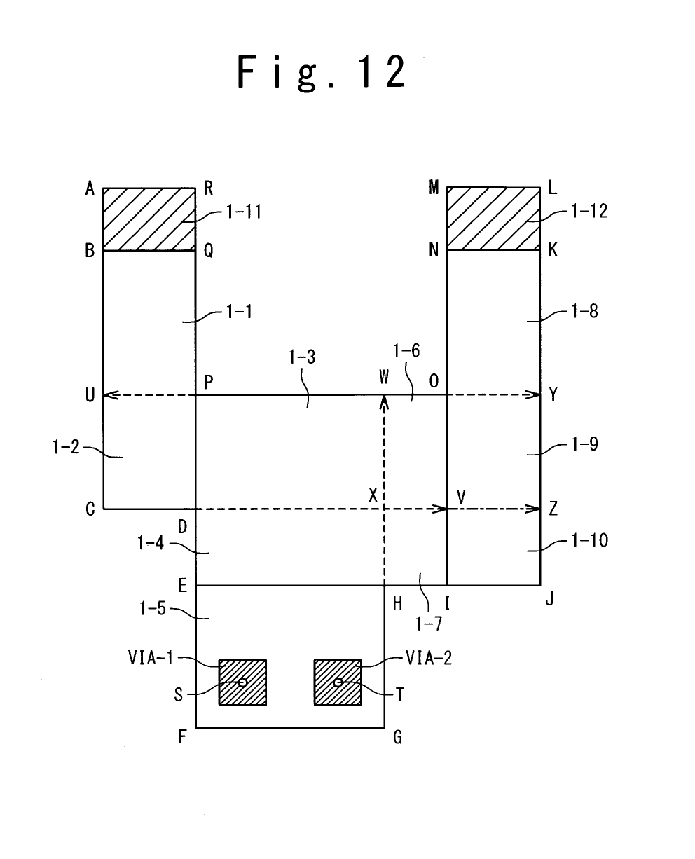

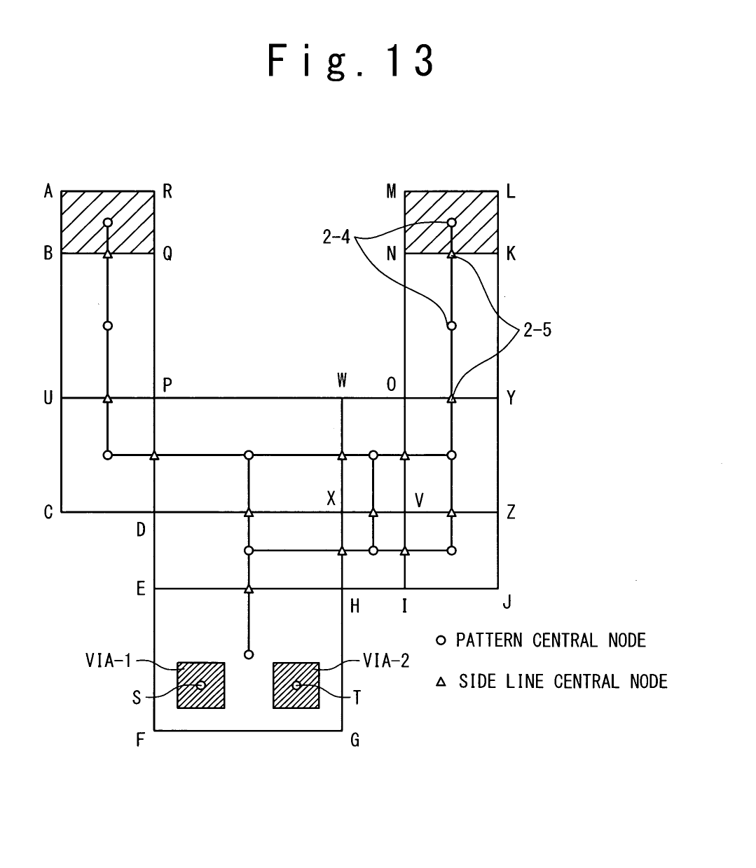

Referring to FIGS. 13 and 14, a process executed by the division pattern processing section 13 will be described specifically. As shown in FIG. 13, the division pattern processing section 13 sets the pattern central nodes 2-4 at the central points of the rectangular patterns after division, respectively. Further, the division pattern processing section 13 sets the side central nodes 2-5 at the cross-points between the segments connecting the central points of the every adjacent rectangular patterns and the sidelines on which the rectangular patterns contact with one another, respectively.

Moreover, the division pattern processing section 13 sets resistances by using the following algorithm (C)

(C) Set a resistance between the pattern central node 2-4 and the side central node 2-5 in one rectangular pattern.

Specifically, as shown in FIG. 14, the division pattern processing section 13 sets resistances to each rectangular pattern 1 to connect the pattern central node 2-4 to each side central node 2-5. As a result, the division pattern processing section 13 sets resistances R1 to R26.

### Step S40: Set Nodes and Resistances to Via-Containing Rectangular Pattern

The via rectangular pattern processing section 14 further sets nodes and resistances to the rectangular pattern 1-5 including via connection positions (hereinafter, to be referred to as “via-containing rectangular patterns”) among the rectangular patterns 1-1 to 1-12. The resistance is set to connect the nodes such that a plurality of resistances do not overlap. Specifically, the via rectangular pattern processing section 14 sets the nodes and the resistances using the following algorithm (D)

(D) Nodes (hereinafter, to be referred to as “perpendicular nodes”) are set at cross-points between perpendicular lines (“first perpendicular lines L1”) from a center of the via-containing rectangular pattern to the respective sidelines of the via-containing rectangular pattern and perpendicular lines (“second perpendicular lines L2”) from the centers of the respective vias to the first perpendicular lines L1. Further, the nodes (hereinafter, to be referred to as “via nodes”) are set at centers of the via connection positions. Then, resistances are set between the nodes.

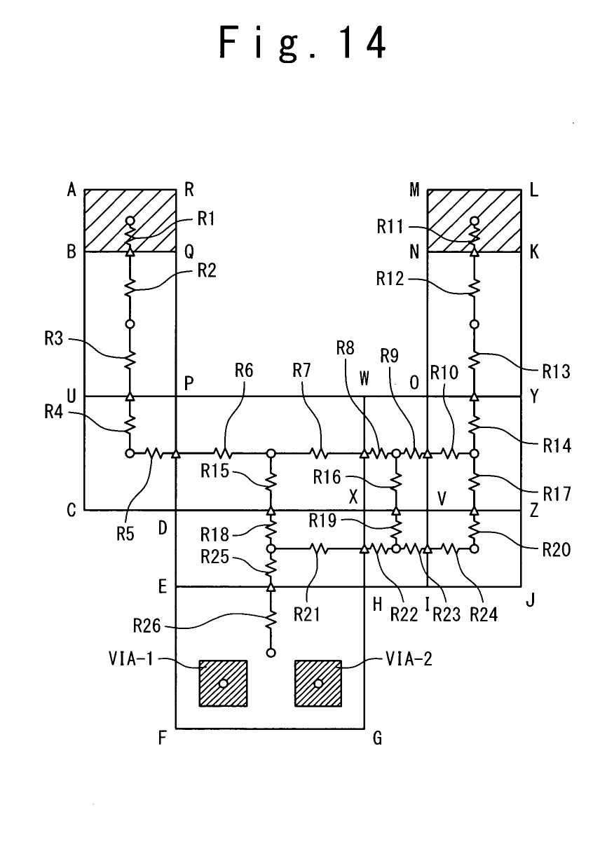

A specific process of the step S40 will be described referring to FIGS. 15 to 17. FIG. 15 is an enlarged view of the via-containing rectangular pattern 1-5. The two via connection positions VIA-1 and VIA-2 are shown in this via-containing rectangular pattern 1-5. It should be noted that the pattern central node is set at the center of the via-containing rectangular pattern 1-5 at the step S30. To discriminate the pattern central node of the via-containing rectangular pattern 1-5 from those of the other rectangular patterns, the pattern central node 2-1 of the via-containing rectangular pattern 1-5 is referred to as a “central node 2-1”, hereinafter. Further, the resistance R26 is set between the central node 2-1 and the side central node 2-5 at the step S30.

As shown in FIG. 15, the via rectangular pattern processing section 14 sets the first perpendicular lines L1 extending from the center of the via-containing rectangular pattern 1-5 to the sidelines thereof. Furthermore, the via rectangular pattern processing section 14 sets via nodes 2-2 at centers of the via connection positions VIA-1 and VIA-2, respectively.

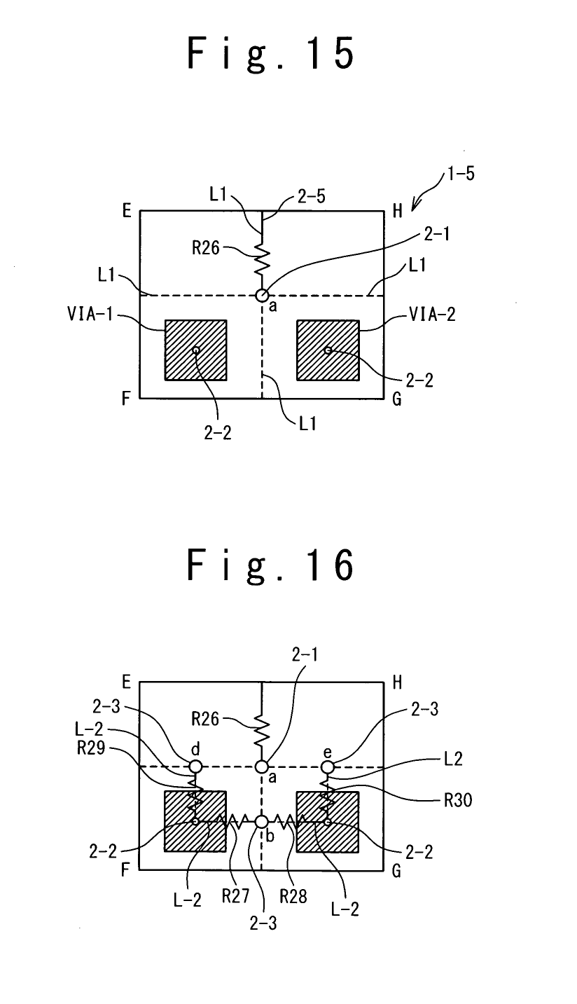

As shown in FIG. 16, the via rectangular pattern processing section 14 sets the second perpendicular lines L2 extending from the via nodes 2-2 to the first perpendicular lines L1. The via rectangular pattern processing section 14 also sets perpendicular nodes 2-3 at cross-points between the first perpendicular lines L1 and the second perpendicular lines L2, respectively.

Next, the via rectangular pattern processing section 14 sets resistances to connect the nodes thus set. At this time, if three or more nodes are set on one line, the via rectangular pattern processing section 14 sets resistances such that a plurality of resistances do not overlap to connect the adjacent nodes. Specifically, while paying first attention to segments between the perpendicular nodes 2-3 and the via nodes 2-2, the via rectangular pattern processing section 14 sets the resistances according to the following procedures 3 and 4.

(Procedure 3) If the other via node is present in the segment between the perpendicular node 2-3 and the via node 2-2, a resistance is set between the two via nodes.

(Procedure 4) If the other via node is not present in the procedure 3, a resistance is set to connect the perpendicular node 2-3 to the via node 2-2 along this segment.

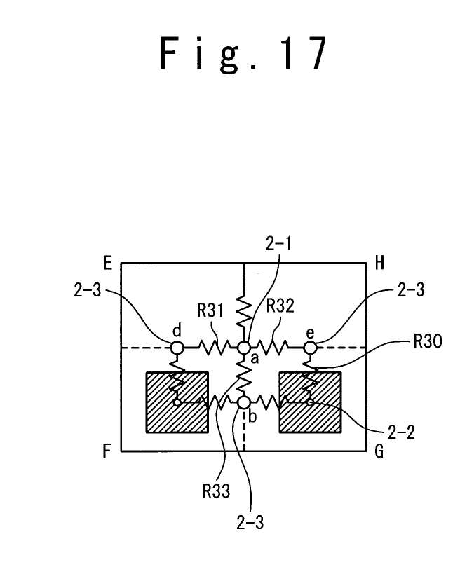

In the first embodiment, since no other via nodes are present between the perpendicular nodes 2-3 and the via nodes 2-2, resistances R27 to R30 are set according to the procedure 4 as shown in FIG. 17.

Moreover, as shown in FIG. 17, resistances R31 to R33 are set between the central node 2-1 and the perpendicular nodes 2-3, respectively.

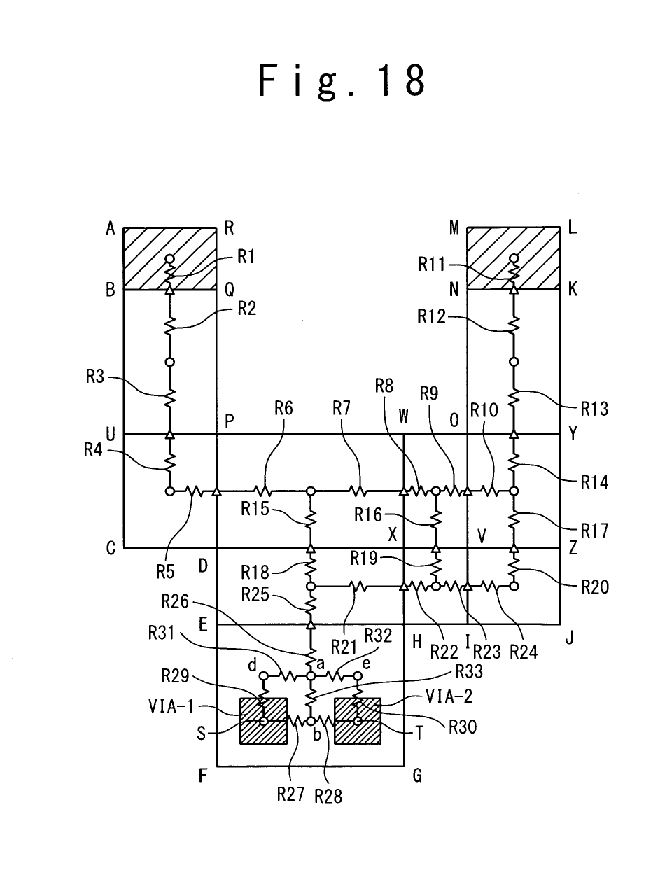

Through the above-stated process, a resistance net shown in FIG. 18 is generated for the wiring pattern shown in FIG. 8.

### Step S50: Calculate Resistance Values.

The resistance value calculating section 15 calculates resistance values of the respective resistances of the resistance net and resistance values of the vias based on a sheet resistance of the wiring pattern and resistance values of the vias which are set into the storage section 20 in advance. Then, the output section 16 outputs data indicating the connection relations among the resistances and the nodes, and the resistance values of the resistances and the vias to the output unit such as a display or a printer as the simulation data.

By using the data for simulation outputted from the resistance net generating apparatus according to the first embodiment, positions (coordinates) of the vias can be accurately represented in the resistance net. This makes it possible to easily identify the positions of the vias when the result of verification such as the EM verification is outputted.

Furthermore, the perpendicular nodes 2-3, the via nodes 2-2, and the central node 2-1 are set in the via-containing rectangular pattern. The resistances are set between the nodes. Thus, it is possible to express flow directions of signals near the vias in more detail during the verification.

Moreover, the wiring pattern is divided by the extension lines extending into the pattern inside from the respective sidelines of the wiring pattern and the nodes are set in correspondence to the patterns after the division. Therefore, it is possible to minimize the numbers of resistances and nodes in the resistance net. As described in the above Japanese Patent No. 3017131, when the resistance net is to be set to divide the wiring pattern in the form of meshes, it is necessary to generate the resistance net by using a finer mesh size in order to accurately express a connection state of the layout pattern. This results in increase in the data size. On contrary, according to the first embodiment, the increase in the data size can be suppressed since it suffices to use the minimum resistances and nodes.

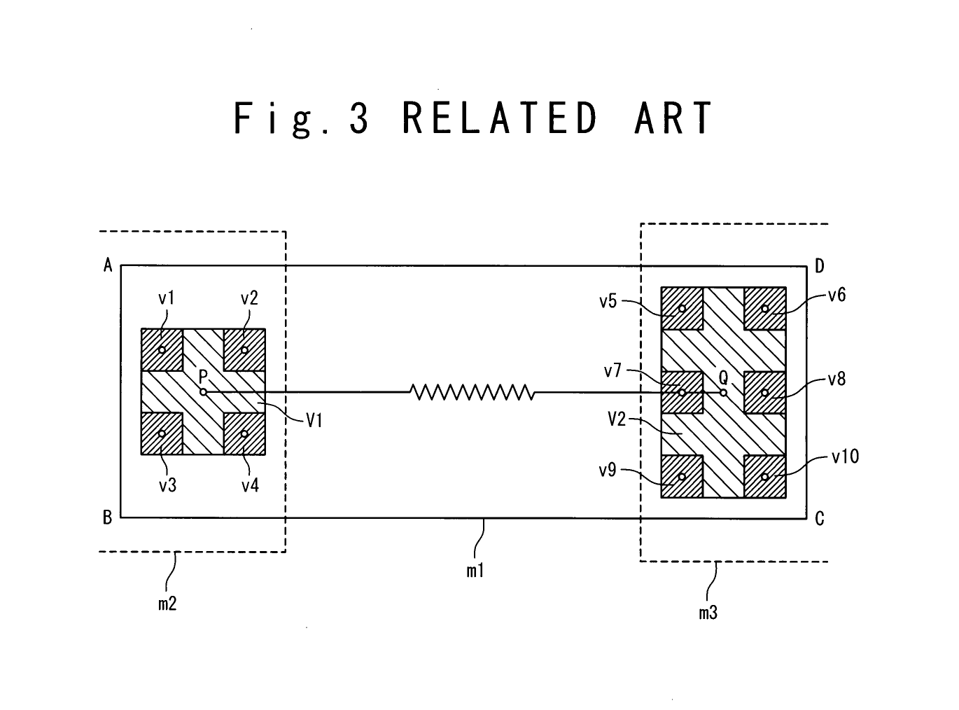

Further, if the wiring pattern is uniformly divided into meshes as described in the above Japanese Patent No. 3017131, the resistances acting as antennas are generated in the peripheral portions of the wiring pattern as shown in FIG. 4. One end of each of the resistance elements acting as antennas is in a floating node state. Such a floating node turns a redundant (an unnecessary resistance). The presence of the unnecessary resistances also causes the increase in the data size. On contrary, according to the first embodiment, no floating nodes are generated. It is, therefore, possible to suppress the increase in the data size from viewpoints of floating nodes.

### Second Embodiment

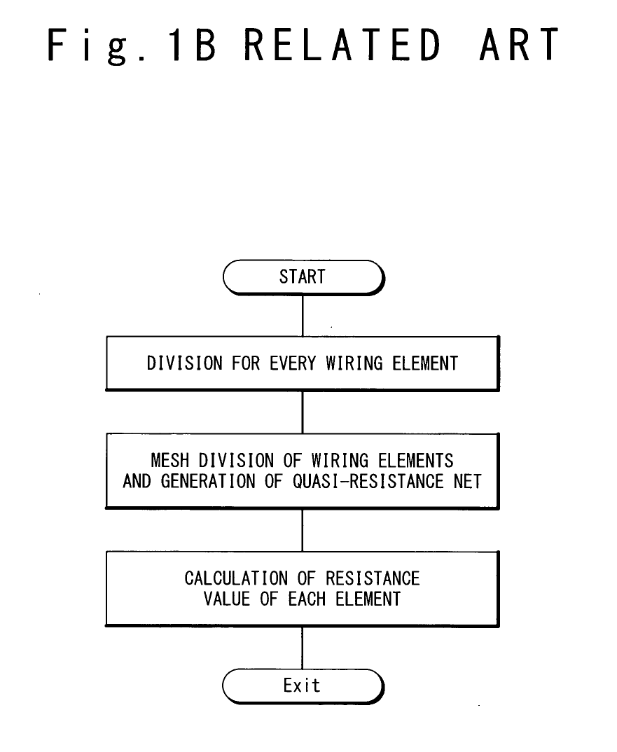

The resistance net generating apparatus according to a second embodiment of the present invention will be described. In the second embodiment, an instance of generating a resistance net for the wiring pattern shown in FIG. 2 by using a resistance net generating apparatus similar to that of the first embodiment will be described. Since basic operation methods according to the second embodiment are similar to those of the first embodiment, the same operations will be omitted.

In case of the wiring pattern shown in FIG. 2, the wiring pattern is already one rectangular pattern and no extension lines extending to the pattern inside from the respective sidelines of the wiring pattern are present. Therefore, the number of rectangular patterns obtained after the division by the dividing section 12 is one and the resultant rectangular pattern is identical in shape to the wiring pattern before the division. Further, the ten vias v1 to v10 are connected in the wiring pattern. Accordingly, this rectangular pattern is regarded per se as the via-containing rectangular pattern.

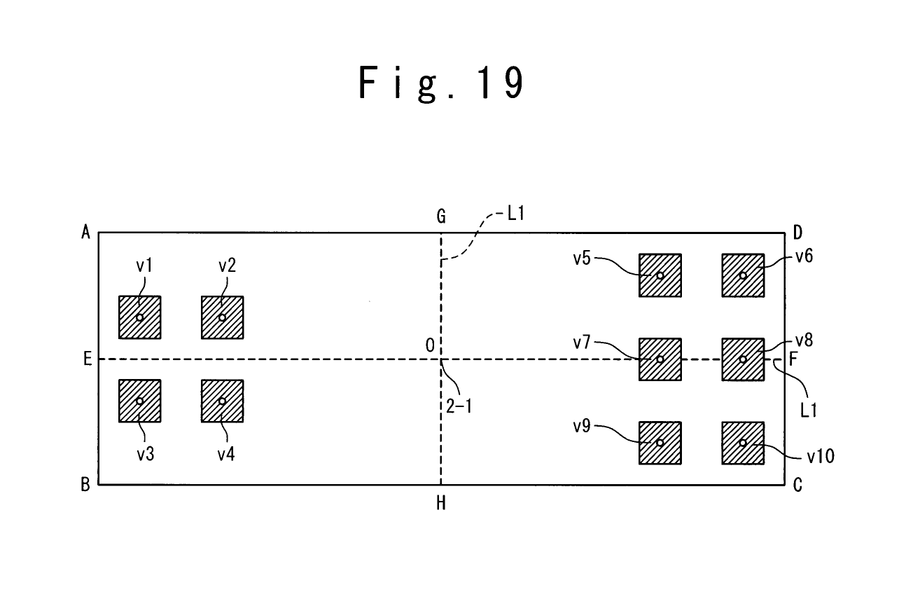

As shown in FIG. 19, the division pattern processing section 13 sets a central node 2-1 at a center O of a pattern ABCD. Further, the division pattern processing section 13 does not set any sideline central nodes since any rectangular pattern adjacent to the pattern ABCD are not present.

The via rectangular pattern processing section 14 makes first perpendicular lines L1 extending from the center O to four sides of the pattern ABCD, respectively. Crosspoints between the first perpendicular lines L1 and the four sidelines are set as E, F, G, and H, respectively.

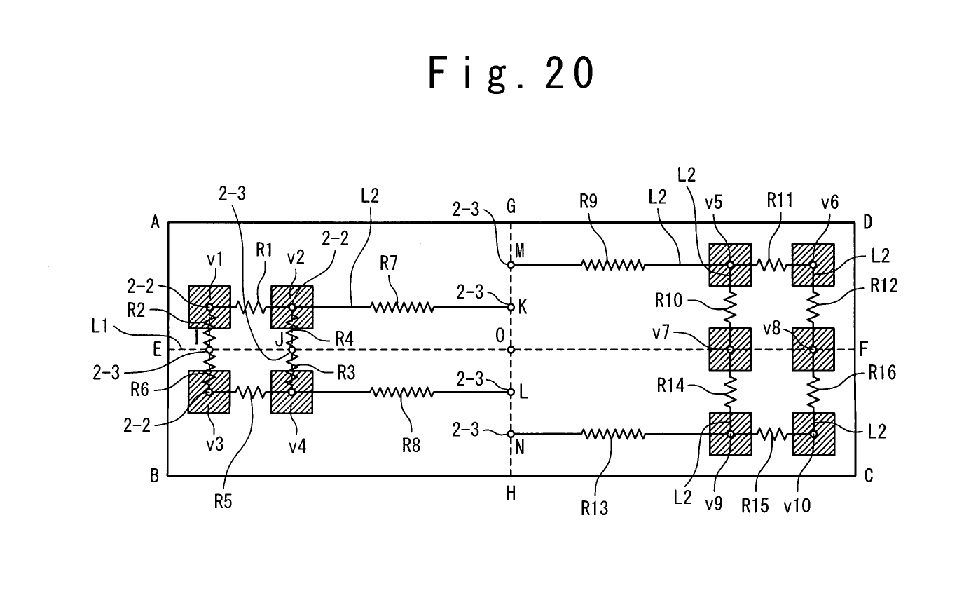

As shown in FIG. 20, the via rectangular pattern processing section 14 sets via nodes 2-2 at centers of the ten vias v1 to v10, respectively. The via rectangular pattern processing section 14 sets second perpendicular lines L2 extending from the vias v1 to v10 toward the first perpendicular lines L1 (OE, OF, OG, and OH), respectively. Further, the via rectangular pattern processing section 14 sets perpendicular nodes 2-3 at cross-points between the first perpendicular lines L1 and the second perpendicular lines L2, respectively.

Attention is now paid to segments connecting the via nodes 2-2 to the perpendicular nodes 2-3. If the other via node is present in each of the segments, a resistance is set to connect the two via nodes. In an example shown in FIG. 20, the via node 2-2 of the via v2 is present between the via node 2-2 of the via v1 and the perpendicular node 2-3 (point K). Therefore, the resistance R1 is set to connect the via nodes of the vias v1 and v2 to each other. Likewise, resistances R5, R11, and R15 are set.

On the other hand, (the center of) the other via is not present in each of the segments connecting the via nodes to the perpendicular nodes 2-3, the resistance is set along the segment. In the example shown in FIG. 20, no other via node is present between the via node of the via v1 and the perpendicular node 2-3. Therefore, the resistance R2 is set to connect the via node 2-2 of the via v1 to the perpendicular node 2-3. Likewise, the resistances R3, R4, R6, R7, R8, R9, R10, R12, R13, R14, and R16 are set.

It should be noted that the via nodes 2-2 of the vias v7 and v8 present on the first perpendicular line L1 are not considered. Namely, resistances along the first perpendicular lines L1 are not set at this stage. As described later, these via nodes are considered at the stage of setting the resistances along the first perpendicular line L1.

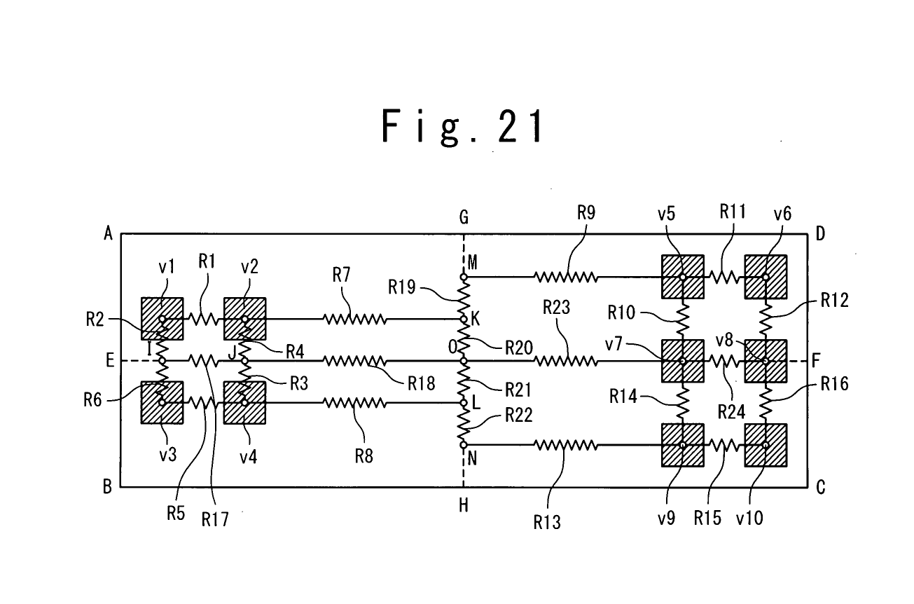

Subsequently, as shown in FIG. 21, the resistances are set to connect the nodes along the perpendicular lines L1. At this time, the resistances are set to connect the adjacent nodes such that a plurality of resistances do not overlap. Namely, resistances R17 and R18 are set between the points I and J and the points J and O on the segment OE, respectively. Further, resistances R19 and R20 are set between the points M and K and the points K and O on the segment OG, respectively. Further, resistances R21 and R22 are set between the point O and L and the points L and N on the segment OH, respectively. Resistances R23 and R24 are set between the point O and the via v7 and the vias v7 and v8 on the segment OF, respectively.

Through the above-mentioned process, a resistance net represented by the nodes accurately indicating the central positions of the respective vias v1 to v10 and the resistances R1 to R24 set to connect the nodes is generated even for the wiring pattern shown in FIG. 2.

According to the second embodiment, the resistance net of the wiring pattern shown in FIG. 2 is represented by the 24 resistances R1 to R24. The number of unnecessary resistances acting as antennas is zero. Central coordinates of the respective vias in the layout pattern are accurately represented. The number of vias is ten and resistance values of the vias are accurately represented.

On contrary, if the wiring pattern is divided into fine meshes as shown in FIG. 4 by using the method described in the above Japanese Patent No. 3017131, the resistance net of the wiring pattern is represented by 192 resistances. The number of unnecessary resistances is 32. Central coordinates of the vias in the layout pattern may possibly be displaced from original coordinates by a/2 at maximum. Therefore, the resistance net cannot be always accurately represented by the method described in the above Japanese Patent No. 3017131. The number of vias is 10 and the resistance values of the vias are accurately represented. This result is a result of assuming AB=CD=0.4 um, BC=DA=1.2 um, mesh division size (corresponding to a value of “a” in FIG. 4)=0.1 um for the wiring pattern ABCD.

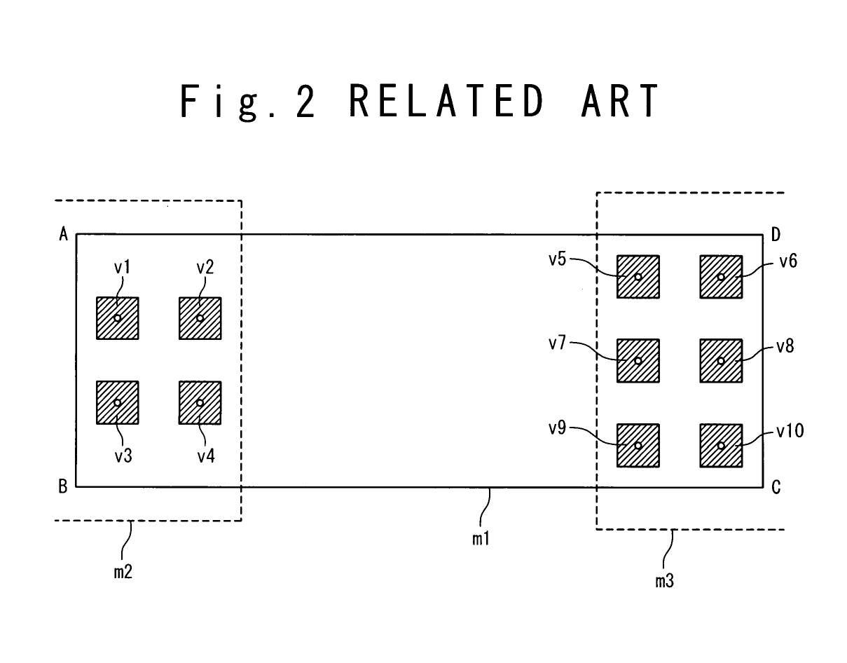

Moreover, as described with reference to FIG. 3, if the method of merging a plurality of vias connecting the wiring patterns into a single via is used, the resistance net is simply represented as a single resistance. The number of unnecessary resistances is zero. A central coordinate of the via in the layout pattern cannot be accurately represented because of merger of a plurality of vias into the single via. The number of vias is two and resistance values of the respective vias are not represented.

Therefore, according to the second embodiment, the coordinates of the respective vias in the layout pattern can be accurately represented differently from the method described with reference to the above Japanese Patent No. 3017131 and FIG. 3. Moreover, differently from the method described in the above Japanese Patent No. 3017131, the number of resistances in the resistance net does not increase and no unnecessary resistances are generated. Differently from the method described referring to FIG. 3, the resistance values of the respective vias can be accurately represented.

Simulation accuracy for an instance of carrying out circuit simulations using the resistance net generated according to the first and second embodiment will be described with an example and first and second comparison examples.

### EXAMPLE

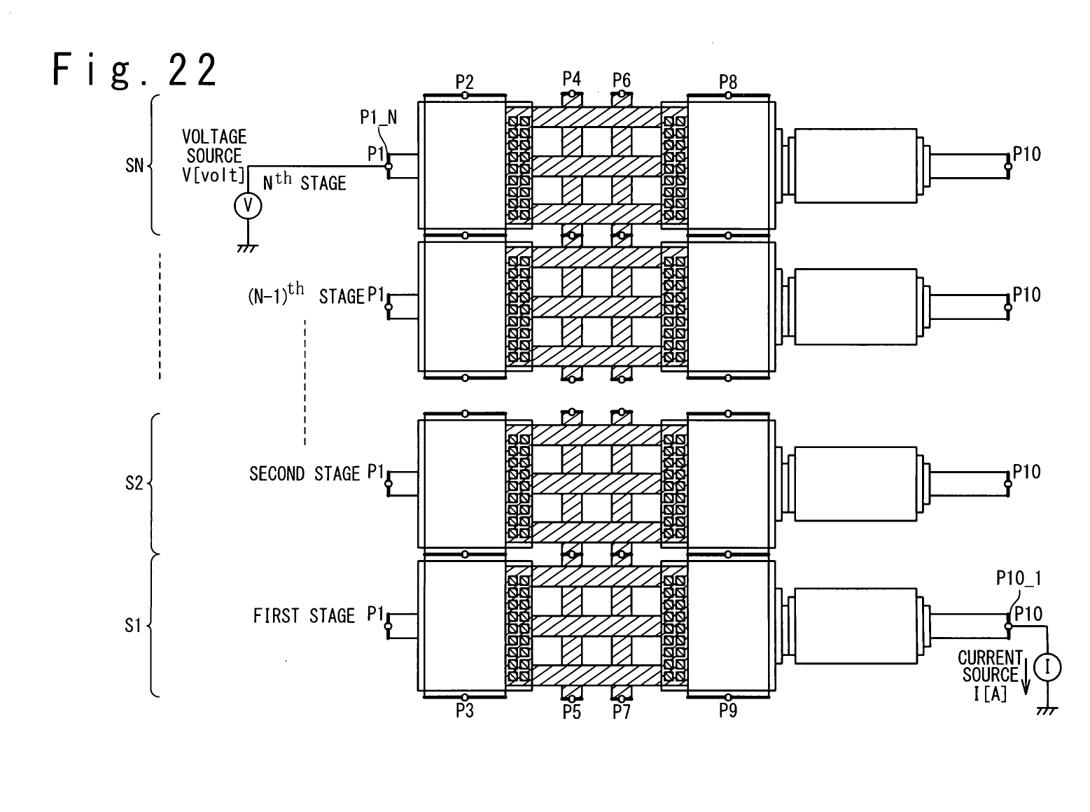

FIG. 22 is a conceptual diagram showing layout patterns for which a resistance net is generated in an example. This layout patterns are assumed to include basic data S1, S2 . . . , and SN of a plurality of stages (N). It is also assumed that patterns in the basic data of the first to N^{th} stages are arranged one-dimensionally.

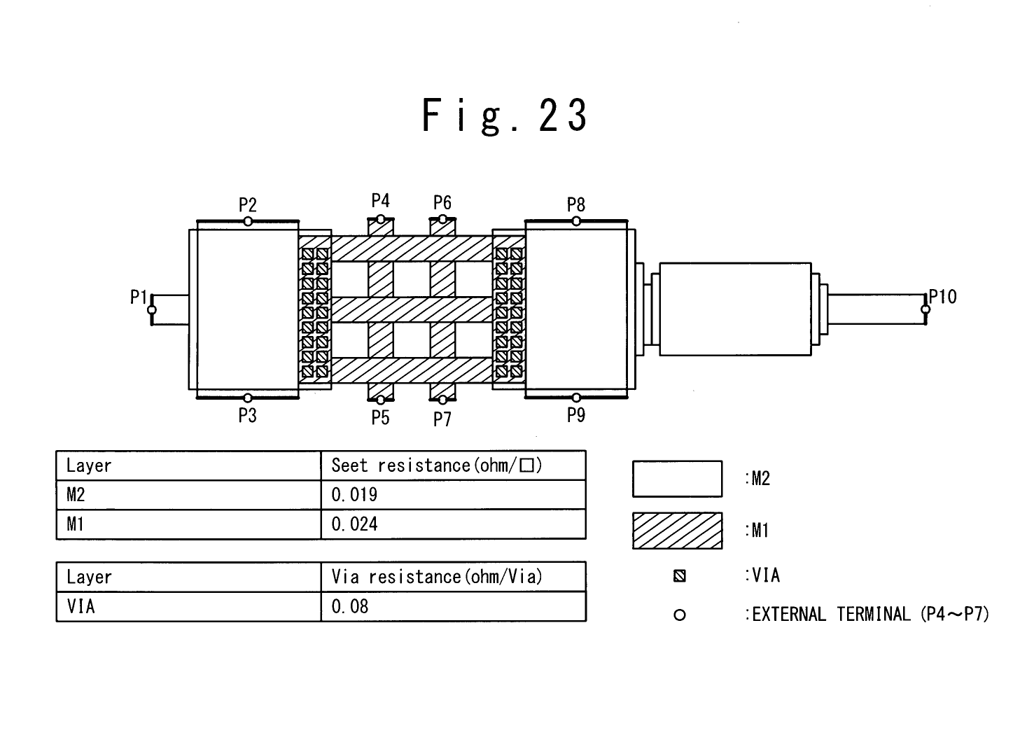

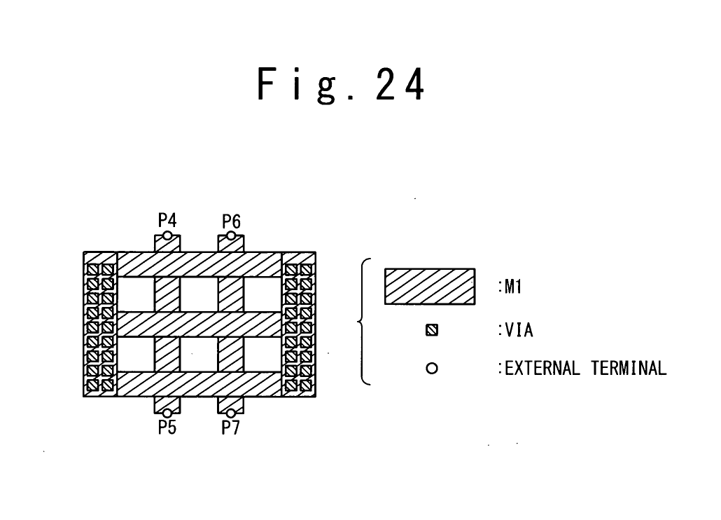

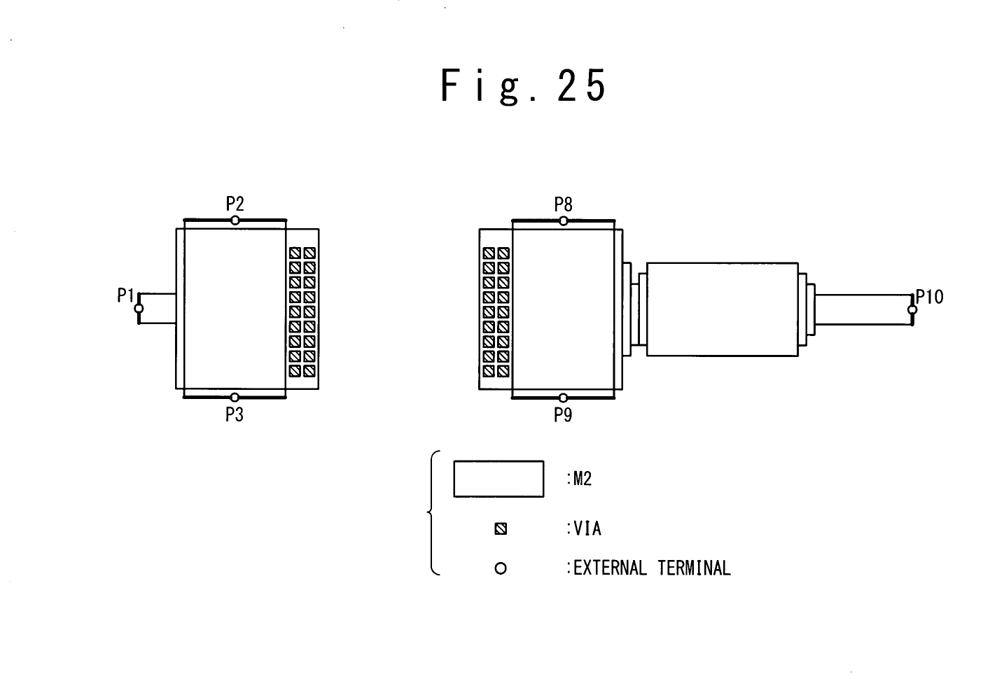

FIG. 23 is a conceptual diagram showing a pattern of each of the basic data. Each basic data has a 2-layer structure of an M1 layer (see FIG. 24) and an M2 layer (see FIG. 25). It is assumed that wiring patterns of the M1 and M2 layers are connected to each other by a plurality of vias. Ten external terminals P1 to P10 are provided in each basic data. As shown in FIG. 22, the external terminals P2, P4, P6, and P8 are connected to the external terminals P3, P5, P7, and P9 of the adjacent basic data on an upper stage side, respectively. The external terminals P3, P5, P7, and P9 are connected to the external terminals P2, P4, P6, and P8 of the adjacent basic data on a lower stage side, respectively. As shown in FIG. 23, a sheet resistance value of the pattern of the M1 layer is set to 0.024 (ohm/□), that of the pattern of the M2 layer is set to 0.019 (ohm/□), and resistance values of respective vias are set to 0.08 (ohm/Via), respectively.

The resistance nets were generated by executing the process at the steps S10 to S40 according to the first embodiment if the number of stages of basic data shown in FIG. 22 is set to 30, 40, and 50 (that is N=30, 40, and 50), respectively.

Descriptions of power supplies and current sources were added to the respective resistance nets, thereby generating netlists for SPICE (Simulation Program with Integrated Circuit Emphasis) (hereinafter, to be referred to as “SPICE netlists”) Specifically, a power supply voltage V [volt] is added to be connected to the external terminal P1 (P1-N in FIG. 22) at a highest stage. A current source I [A] is added to be connected to the external terminal P10 (P10-1 in FIG. 22) at a lowest stage.

Using the generated SPICE netlist, resistance values between the two points, i.e., the external terminal P1 at the highest stage and the external terminal P10 at the lowest stage was measured through computer simulation. Specifically, a SPICE DC analysis (direct-current operation analysis) was first performed to calculate the voltage of the external terminal P10 at the lowest stage and the voltage was set as V1. Further, the resistance value R between the two points, i.e., the external terminal P1 at the highest stage and the external terminal P10 at the lowest stage was calculated according to the following calculational expression.

R=(V−V1)/I

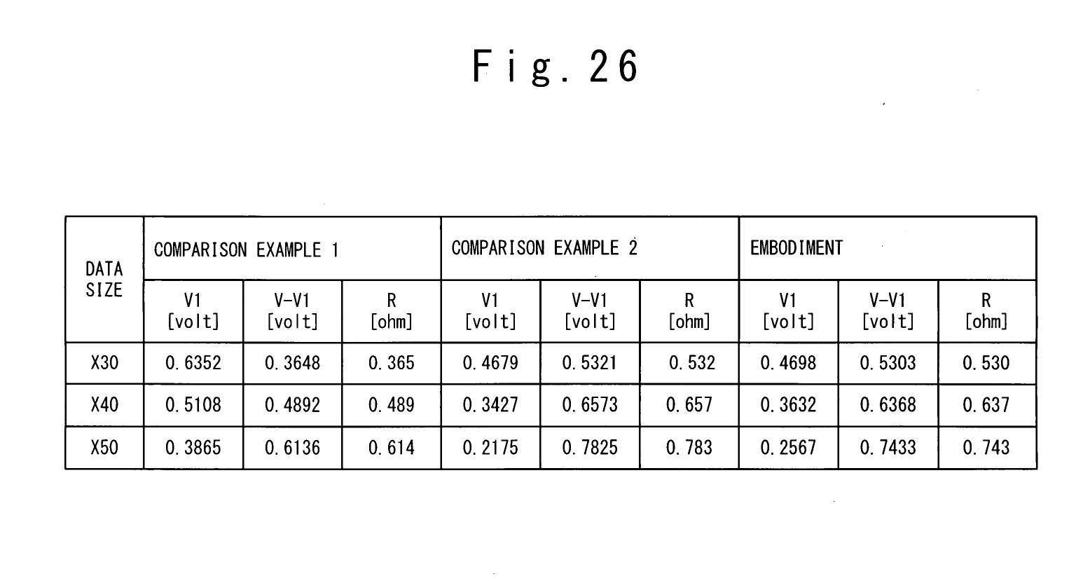

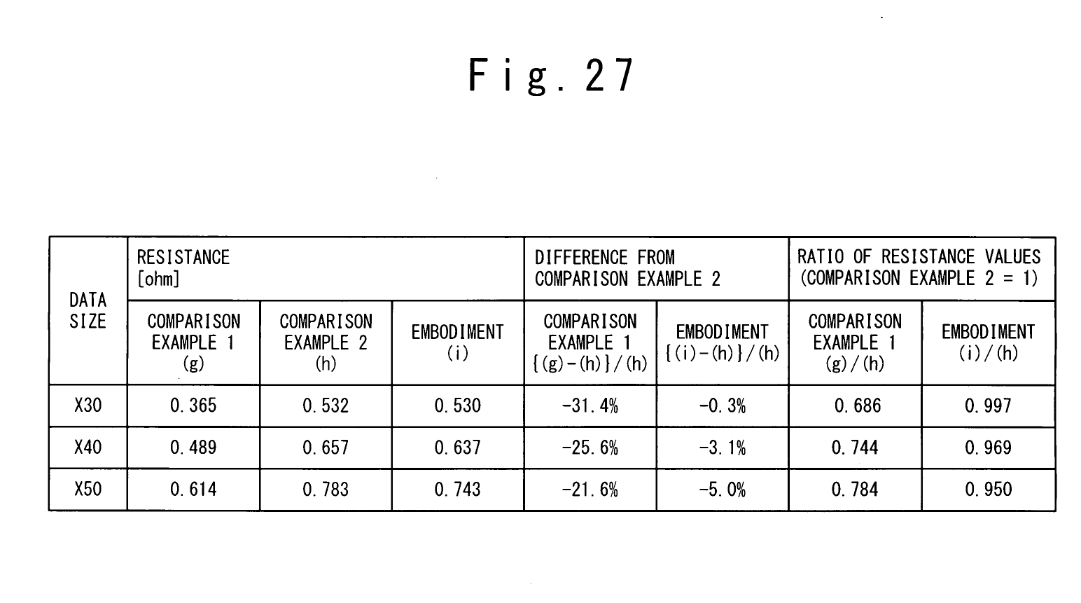

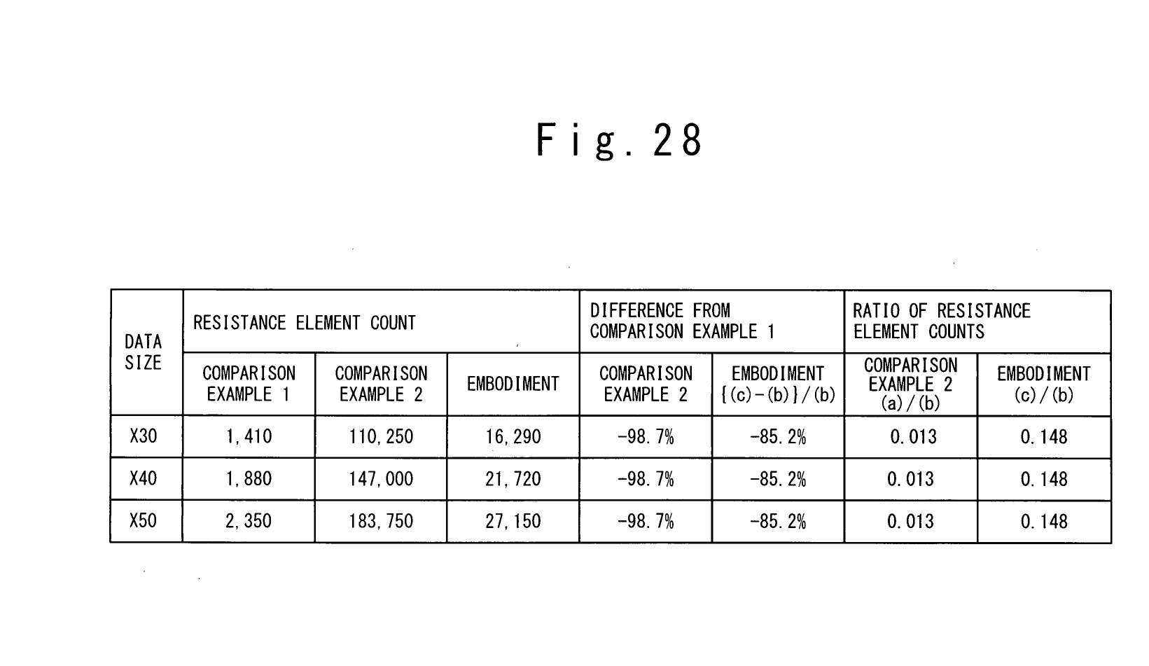

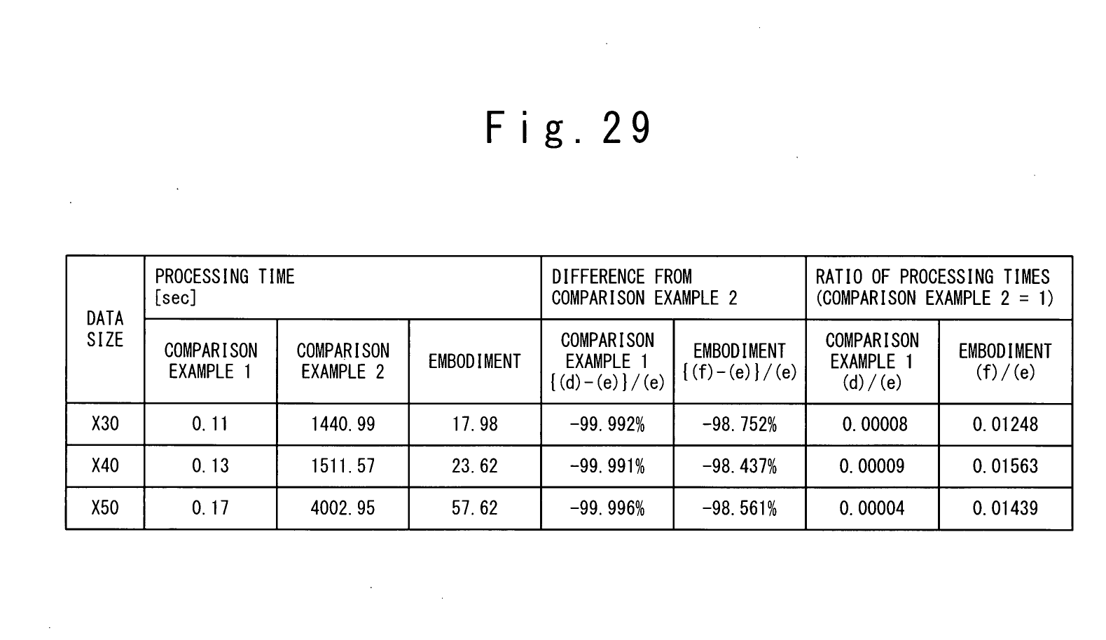

FIGS. 26 and 27 show calculation results of the voltages V1 and the resistance values R when V=1 [volt] and I=1 [A]. FIG. 28 shows the numbers of resistances in the generated resistance nets. FIG. 29 shows execution time required for DC analyses of SPICE netlist, respectively. In FIGS. 26 to 29, the result for N=30 corresponds to data scale=×30, that for N=40 corresponds to data scale=×40, and that for N=50 corresponds to data scale=×50.

### First Comparison Example

A resistance net was generated by applying the method of merging a plurality of vias into a single via to the same layout pattern as that in the example, as described with reference to FIG. 3. Similarly to the example, an SPICE DC analysis (direct-current operation analysis) was performed to calculate a resistance value R between the two points, i.e., the external terminal P1 at the highest stage and the external terminal P10 at the lowest stage, the number of resistances in the resistance net, and a DC analysis execution time. FIGS. 26 to 29 show calculation results.

It should be noted that to merge the plurality of vias into the single via, a group of vias connecting wiring patterns was merged into the single via. The vias before the merging were regarded as ones to connect the wiring patterns in parallel, and a resistance value of the via after the merging was calculated as a synthetic resistance value of the vias before the merging.

### Second Comparison Example

A resistance net was generated by applying the method of setting resistances and nodes in the form of meshes to the same layout pattern as that in the example, as described in the above Japanese Patent No. 3,017,131. Similarly to the example, an SPICE DC analysis (direct-current operation analysis) was executed to calculate a resistance value R between the two points, i.e., the external terminal P1 at the highest stage and the external terminal P10 at the lowest stage, the number of resistances in the resistance net, and a DC analysis execution time. FIGS. 26 to 29 show calculation results.

It should be noted that too generate each of the resistance nets, the resistances were set in detail so as to be able to obtain resistance value R close to a true value by the DC analysis. Specifically, the resistance net was generated so that the number of resistances in the resistance net is about 6.8 times as large as that in the example.

FIGS. 27 to 29 also show differences of the example and the first comparison example from the second comparison example. The differences are calculated according to {(Example)−(Second comparison example)}/(Second comparison example) and represented in percentage.

Referring to FIG. 27, an accuracy of the DC analysis results will be described. As already stated, the resistance nets were set sufficiently in detail. Therefore, the accuracy can be said to be high for the resistance values R obtained by the DC analyses. If the differences from the second comparison example are smaller, the accuracies of the resistance values R obtained by the DC analyses are higher. As shown in FIG. 27, in case of data scale=×30, the resistance value R obtained by the DC analysis in the example was 0.530 (ohm) and the difference was −0.3%. On the other hand, in the first comparison example, the resistance value R was 0.365 (ohm) and the difference was −31.4%. Therefore, it was confirmed that the DC analysis was conducted with high accuracy in the example since the example is almost identical in value to the second comparison example. On the other hand, it was confirmed that the DC analysis was conducted with low accuracy since the difference from the second comparison example was as great as −31.4%. Likewise, in case of data scale=×40 and data scale=×50, the difference of the example from the second comparison example was within −5% and it is confirmed that the DC analysis was conducted with sufficiently high accuracy in the example.

Moreover, as shown in FIG. 28, in the example, the number of resistances in each of the generated resistance nets decreased by about 85% of that in the second comparison example. Thus, it was confirmed that the resistance nets could be generated without the increase in the data size in the example.

Furthermore, as shown in FIG. 29, in the example, the execution time required for each of the DC analyses was decreased by about 99% of that in the second comparison example. Thus, it was confirmed that the time required to conduct a simulation by a computer could be reduced in the example.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A resistance net generating apparatus comprising:
a dividing section configured to acquire a data of a wiring pattern which contains connection position with vias and to divide said wiring pattern into rectangular patterns;
a division pattern processing section configured to set nodes and resistances base on said rectangular patterns; and
an output section configured to output positions of the nodes and the resistances as a resistance net specifying data,
wherein said wiring pattern is represented by sidelines extending into an X direction and a Y direction orthogonal to the X direction, and
said dividing section divides said wiring pattern into said rectangular patterns by extension lines extending from said sidelines into an inside of said wiring pattern.

2. The resistance net generating apparatus according to claim 1, wherein said division pattern processing section sets a pattern central node at a center of each of said rectangular patterns, sets a side central node at a center of the sideline common between said rectangular patterns when there are a plurality of said rectangular patterns, and sets a resistance to connect said pattern central node and said side central node.

3. A resistance net generating apparatus comprising:
a dividing section configured to acquire a wiring pattern which contains connection position with vias and to divide said wiring pattern into rectangular patterns;
a division pattern processing section configuration to set nodes and resistances based on the rectangular patterns;
a via rectangular pattern processing section configured to set nodes and resistances to a via pattern for said vias; and
an output section configured to output positions of the resistance and the node as resistance net specifying data,
wherein said via pattern is a via rectangular pattern containing the connection position of the vias,
said via rectangular pattern processing section sets to the via rectangular pattern, a central node at a center of the via rectangular pattern, a via node in a center of the connection position of the via, a first perpendicular line extending from the central node to each of sidelines of the via rectangular pattern, a second perpendicular line extending from the via node to said first perpendicular line, and a perpendicular line node at a cross point of the first and second perpendicular lines, and
said division pattern processing section and said via rectangular pattern processing section set the resistances to connect the nodes.

4. The resistance net generating apparatus according to claim 3, wherein said via rectangular pattern processing section further sets a resistance to connect the via node and the perpendicular line node, and a resistance to connect the perpendicular line node and the central node.

5. The resistance net generating apparatus according to claim 3, wherein when three or more nodes are set on one straight line, said via rectangular pattern processing section sets resistances to connect adjacent two of the three or more nodes.

6. The resistance net generating apparatus according to claim 3, wherein said wiring pattern is represented by sidelines extending into an X direction and a Y direction orthogonal to the X direction, and
said dividing section divides said wiring pattern into the rectangular patterns by an extension line of each of the sidelines of said wiring pattern into an inside thereof.

7. The resistance net generating apparatus according to claim 6, wherein said division pattern processing section sets a pattern central node at a center of each of said rectangular patterns, sets a side central node at a center of the sideline common to said rectangular patterns when there are a plurality of said rectangular patterns, and sets a resistance to connect said pattern central node and said side central node.

8. A computer-readable software medium in which codes of a program for a resistance net generating method are stored, wherein said resistance net generating method comprises:
acquiring a data of a wiring pattern which contains connection position with vias, wherein said wiring pattern is represented by sidelines extending into an X direction and a Y direction orthogonal to the X direction;
dividing said wiring pattern into rectangular patterns by extension lines extending from said sidelines into an inside of said wiring pattern;
setting nodes and resistances base on said rectangular patterns; and
outputting positions of the nodes and the resistances as a resistance net specifying data.

9. The computer-readable software medium according to claim 8, wherein said setting comprises:
setting a pattern central node at a center of each of said rectangular patterns;
setting a side central node at a center of the sideline common between said rectangular patterns when there are a plurality of said rectangular patterns; and
setting a resistance to connect said pattern central node and said side central node.
